(19) United States
(12) Patent Application Publication
(10) Pub. No.: US 2025/0246688 A1
(43) Pub. Date: Jul. 31, 2025

(54) LITHIUM BATTERY AND ELECTRIC DEVICE

(71) Applicant: BYD COMPANY LIMITED, SHENZHEN (CN)

(72) Inventors: Wei ZHANG, Shenzhen (CN); Honghong LI, Shenzhen (CN); Jing JIN, Shenzhen (CN); Yudong LEI, Shenzhen (CN)

(21) Appl. No.: 19/078,944

(22) Filed: Mar. 13, 2025

Related U.S. Application Data
(63) Continuation of application No. PCT/CN2023/120029, filed on Sep. 20, 2023.

(30) Foreign Application Priority Data
Sep. 26, 2022 (CN) 202211169554.5

(51) Int. Cl. H01M 10/0585; H01M 4/02; H01M 4/13; H01M 10/0525; H01M 10/0567

(52) U.S. Cl. CPC H01M 10/0585; H01M 4/13; H01M 10/0525; H01M 10/0567; H01M 2004/021

(57) ABSTRACT

A lithium battery includes a positive electrode plate, a negative electrode plate, a separator, and an electrolyte solution. The negative electrode plate includes a current collector and a negative electrode active material layer disposed on one side surface of the current collector. The electrolyte solution includes a lithium salt, an organic solvent, and an additive. The additive includes a fluorinated carbonate and a nitrile substance. The negative electrode active material layer has a thickness of D₁ μm. A particle size is Dᵥ50 μm when a negative electrode active material has a volume cumulative distribution percentage of 50%. A particle size is Dᵥ90 μm when the negative electrode active material has a volume cumulative distribution percentage of 90%. A weight content of the fluorinated carbonate is W₀%. A weight content of the nitrile substance is W₁%. The lithium battery has a performance factor k, k=(2D₁/Dᵥ90+Dᵥ50)/(W₀+W₁), and 0.5<k<3.0.

### CROSS-REFERENCE TO RELATED APPLICATIONS

This application is a continuation application of International Patent Application No. PCT/CN2023/120029, filed on Sep. 20, 2023, which is based on and claims priority to and benefits of Chinese Patent Application No. 202211169554.5 filed on Sep. 26, 2022. The entire content of all of the above-referenced applications is incorporated herein by reference.

### FIELD

The present disclosure relates to the technical field of batteries, and particularly to a lithium battery and an electric device.

### BACKGROUND

Lithium-ion batteries (also known as “lithium batteries”), due to a high voltage, long life, no memory effect, and other characteristics, are widely used in mobile electronic devices, electric vehicles, drones, and other fields. With the continuous development of products powered by lithium-ion batteries, higher requirements are raised for the energy density, cycle performance, and safety performance of lithium-ion batteries.

During the charging and discharging process of lithium-ion batteries, the negative electrode active material undergoes lithium intercalation and deintercalation constantly, causing a solid electrolyte interface (SEI) film on the surface of the negative electrode active material to continuously crack and generate a new interface. This leads to the direct contact of the negative electrode active material with the electrolyte solution and the occurrence of side reactions, causing the loss of active lithium and thus reducing the energy density and cycle life of the batteries. In addition, the stability of the SEI film formed on the surface of the negative electrode also directly affects the stability of the lithium-ion batteries tested in a furnace-temperature test, which is directly related to the safety performance of the lithium-ion batteries.

Currently, there are no effective technical solutions that can make the battery practically have a good long-cycle ability and safety performance.

### SUMMARY

In view of this, the present disclosure provides a lithium-ion battery and an electric device. By configuring a relative relation between the thickness of the negative electrode active material layer, the particle size of the negative electrode active material, and the electrolyte solution, the lithium-ion battery is ensured to have a long cycle life and a good furnace-temperature performance at 130° C.

In a first aspect, the present disclosure provides a lithium battery. The lithium battery includes a positive electrode plate, a negative electrode plate, a separator, and an electrolyte solution. The negative electrode plate includes a current collector and a negative electrode active material layer disposed on at least one side surface of the current collector. The electrolyte solution includes a lithium salt, an organic solvent, and an additive, where the additive includes a fluorinated carbonate and a nitrile substance. The negative electrode active material layer has a thickness of D₁ μm. The corresponding particle size is Dᵥ50 μm when the negative electrode active material contained in the negative electrode active material layer has a volume cumulative distribution percentage of 50%, and the corresponding particle size is Dᵥ90 μm when the negative electrode active material contained in the negative electrode active material layer has a volume cumulative distribution percentage of 90%. Based on the total weight of the electrolyte solution, the weight content of the fluorinated carbonate is W₀%, and the weight content of the nitrile substance is W₁%. The lithium battery has a performance factor k, k=(2D₁/Dᵥ90+Dᵥ50)/(W₀+W₁), and k is from about 0.5 to about 3.0.

By adding the fluorinated carbonate and the nitrile substance as additives to the electrolyte solution, a stable and dense SEI film is formed on the negative electrode and an oxidation-resistant protective film is formed on the positive electrode to prevent the decomposition of the electrolyte solution and thus the gas generation on the positive electrode. By virtue of the co-working of these two additives and a quantitative relation established between their contents and the thickness of the negative electrode and the particle size of the negative electrode active material, the performance factor k of the battery is defined. By controlling k in the range of 0.5 to 3, the purpose of improving the cycle performance and furnace-temperature performance of the lithium battery can be achieved.

In some embodiments, k is from about 1.0 to about 2.0.

In some embodiments, W₀ is from about 2 to about 16.

In some embodiments, W₀ is from about 5 to about 10.

In some embodiments, W₁ is from about 2 to about 10.

In some embodiments, a ratio W₀/W₁ of W₀ to W₁ is from about 0.5 to about 4.

In some embodiments, a ratio W₀/W₁ of W₀ to W₁ is from about 1.5 to about 3.0.

In some embodiments, D₁ is from about 30 to about 90.

In some embodiments, D₁ is from about 40 to about 80.

In some embodiments, the particle sizes of the negative electrode active material meet: 8≤Dᵥ50<Dᵥ90≤40.

In some embodiments, a ratio D₁/Dᵥ90 of D₁ to Dᵥ90 is greater than or equal to 1.

In some embodiments, the fluorinated carbonate includes at least one of fluoroethylene carbonate, 4,5-difluoroethylene carbonate, 4,4,5,5-tetrafluoroethylene carbonate, and 4-trifluoromethylethylene carbonate. The nitrile substance includes at least one of succinonitrile, adipodinitrile, glutaronitrile, butenedinitrile, 1,4-dicyano-2-butene, 3,3′-oxydipropionitrile, ethylene glycol diacetonitrile ether, 1,2,3-tri(2-cyanooxy)propane, 1,3,5-pentanetricarbonitrile, 1,2,3-propanetricarbonitrile, and 1,3,6-hexanetricarbonitrile.

In some embodiments, the organic solvent includes a carboxylate substance. The carboxylate substance includes at least one of ethyl acetate, propyl acetate, ethyl propionate, propyl propionate, butyl propionate, pentyl propionate, ethyl haloacetate, ethyl halopropionate, propyl halopropionate, butyl halopropionate, and amyl halopropionate.

In some embodiments, the organic solvent further includes a cyclic carbonate.

In some embodiments, the organic solvent further includes a linear carbonate substance.

In some embodiments, based on the total weight of the electrolyte solution, the total weight content of the carboxylate substance is W₂%, and W₂/W₀≥2.

In some embodiments, a ratio W₂/W₀ of W₂ to W₀ is about 2.5 to about 8.

In some embodiments, the additive further includes at least one of 1,3-propanesultone, vinylene carbonate, and vinylethylene carbonate.

In a second aspect, the present disclosure provides an electric device. The electric device includes a lithium battery according to the first aspect of the present disclosure.

Due to the use of the lithium battery, the battery of the electric device has a long battery life, a good cycle performance, and a high safety.

### BRIEF DESCRIPTION OF THE DRAWINGS

FIG. 1 is a schematic structural view of a lithium battery according to an embodiment of the present disclosure.

FIG. 2 is a schematic structural view of an electric device according to an embodiment of the present disclosure.

### DETAILED DESCRIPTION

The technical solution according to the embodiments of the present disclosure is described in detail hereinafter.

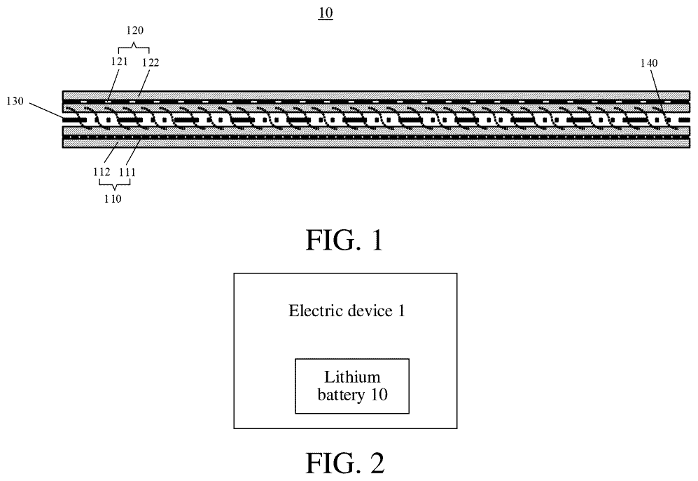

An embodiment of the present disclosure provides a lithium battery. As shown in FIG. 1, a lithium battery 10 includes a positive electrode plate 110, a negative electrode plate 120, a separator 130, and an electrolyte solution 140. The negative electrode plate 120 includes a negative electrode current collector 121 and a negative electrode active material layer 122 arranged/disposed on at least one side surface of the negative electrode current collector 121. The electrolyte solution includes a lithium salt, an organic solvent, and an additive, where the additive includes a fluorinated carbonate and a nitrile substance. The negative electrode active material layer 122 has a thickness of D₁ μm. The corresponding particle size is Dᵥ50 μm when the negative electrode active material contained in the negative electrode active material layer 122 has a volume cumulative distribution percentage of 50%, and the corresponding particle size is Dᵥ90 μm when the negative electrode active material contained in the negative electrode active material layer 122 has a volume cumulative distribution percentage of 90%. Based on the total weight of the electrolyte solution 140, the weight content of the fluorinated carbonate is W₀%, and the weight content of the nitrile substance is W₁%. The lithium battery 10 has a performance factor k meeting a relation formula below:

$$K = \frac{\frac{2 {D}_{1}}{{D}_{v} 90} + {D}_{v} 50}{{W}_{0} + {W}_{1}} ,$$

and k is in the range of about 0.5-3.0.

In some embodiments of the present disclosure, as shown in FIG. 1, the positive electrode plate 110 includes a positive electrode current collector 111 and a positive electrode active material layer 112 arranged on at least one side surface of the positive electrode current collector 111.

In the present disclosure, the fluorinated carbonate and the nitrile substance are added as additives to the electrolyte solution of the lithium battery. By virtue of the high affinity of the fluorinated carbonate to the negative electrode active material, a stable and dense SEI film can be formed on the surface of the negative electrode, to avoid the continuous cracking and reconstruction of the SEI film, reduce the decomposition of the electrolyte solution and the consumption of active lithium, and improve the cycle performance of the battery. However, the fluorinated carbonate is prone to oxidation to generate gas at the positive electrode interface of the lithium battery. After the nitrile substance is introduced, the nitrile substance can be complexed to the positive electrode interface to form a protective film that isolates the electrolyte solution from the positive electrode active material, reduces the dissolution of metal ions from the positive electrode, and reduces the oxidative decomposition of the electrolyte solution by the positive electrode active material, thus improving the furnace-temperature performance of the battery. Therefore, the fluorinated carbonate and the nitrile substance are used as additives in combination in the present disclosure. With functions complementing each other, a relation is established between the contents of the two substances and the particle size of the negative electrode active material and the thickness of the negative electrode active material layer, and the performance factor k of the battery is defined. k is controlled in the range of about 0.5-3, to ensure that the lithium battery can well have a long cycle life and a good furnace-temperature performance.

After analysis, the possible reason is speculated by the applicant to be that D₁/Dᵥ90 can reflect the degree of fragmentation of the negative electrode active particles during the rolling process of the negative electrode plate to a certain extent. Dᵥ50 reflects the overall size of the negative electrode active material particles, for example, the number of active sites on the surface of the negative electrode active material particles, and the degree of fragmentation of the particles during rolling. However, the cracking of the negative electrode active particles will produce more active interfaces, which causes the increased consumption of the electrolyte solution in the formation and cycle process, the loss of capacity of the negative electrode active material, and the easy lithium plating on the surface of the negative electrode during the charging process. The fluorinated carbonate can form a stable SEI film on the negative electrode that is beneficial to the cycle, but it is prone to oxidation to generate a gas at the positive electrode interface. The nitrile substance can form a protective film at the positive electrode interface that isolates the electrolyte solution from the positive electrode active material. However, the compatibility of the nitrile substance with the negative electrode active materials is not very good, and has a certain impact on the cycle performance. The influence of the above parameters on the battery performance is diverse, mutual, and difficult to quantify. However, (2D₁/Dᵥ90+Dᵥ50)/(W₀+W₁) can reflect the comprehensive influence of the negative electrode plate and the electrolyte solution on the cycle performance, furnace-temperature performance, and lithium plating of the battery. By controlling (2D₁/Dᵥ90+Dᵥ50)/(W₀+W₁) in the range of about 0.5-3, the cycle performance, and furnace-temperature performance, lithium plating and other safety performance of the battery can be well balanced, so as to improve the comprehensive performance of the battery.

In the present disclosure, Dᵥ90 and Dᵥ50 of the negative electrode active material can be determined as follows. The negative electrode plate disassembled from the battery is soaked in dimethyl carbonate (DMC) for 1 h (hour), then taken out, washed twice with DMC to remove the residual electrolyte solution on the surface of the electrode plate, and naturally air-dried. The air-dried electrode plate is immersed in deionized water until the negative electrode material is separated from the current collector. Then the negative electrode material is dried in an oven at 100° C. to remove water. Next, the dried negative electrode material is heat-treated in a tube furnace at 800° C. under a helium atmosphere for 6 h, to remove the binder and thickener in the negative electrode material, and thus obtain the negative electrode active material. Finally, the particle size distribution of the obtained negative electrode active material is tested by laser diffraction, and Dᵥ90 and Dᵥ50 are acquired from the obtained particle size distribution curve. The test method can be found in GB/T 19077-2016/ISO 13320:2009 particle size analysis-Laser diffraction methods. The instrument for detecting Dᵥ90 and Dᵥ50 is generally a laser particle sizer analyzer (such as Malvin 3000 laser particle analyzer). The corresponding particle size Dᵥ50 when the negative electrode active material has a volume cumulative distribution percentage of 50% can also be referred to as “median particle size” of the material. Additionally, W₀ and W₁ can be obtained by analyzing the composition of the electrolyte solution. D₁ can be obtained by directly or indirectly determining the thickness of the negative electrode active material layer, and refers to the thickness of the single-sided negative electrode active material layer.

In some embodiments of the present disclosure, the parameter k is in the range of about 1.0-2.0. In this case, the lithium battery can better balance the cycle performance and the furnace-temperature performance, so as to have a better comprehensive performance.

In an embodiment of the present disclosure, the fluorinated carbonate includes a fluorinated cyclic carbonate. The fluorinated cyclic carbonate may include one or more of fluoroethylene carbonate, 4,5-difluoroethylene carbonate, 4,4,5,5-tetrafluoroethylene carbonate, and 4-trifluoromethylethylene carbonate.

In some embodiments of the present disclosure, W₀ is in the range of: 2≤W₀≤16. In other words, based on the total weight of the electrolyte solution, the weight content of the fluorinated carbonate is about 2%-16%. In an embodiment, the weight content may be 2.1%, 2.5%, 3%, 3.5%, 4%, 4.5%, 5.5%, 6%, 8%, 9%, 11%, 12%, 14%, 15%, or 15.5%. That is, W₀ may be 2.1, 2.5, 3, 3.5, 4, 4.5, 5.5, 6, 8, 9, 11, 12, 14, 15, or 15.5. In some embodiments, 6≤W₀≤12. In this case, the parameter k can be set in a range of 1-2, to allow the battery to have a low battery core expansion rate and a good furnace-temperature test result, while the battery is ensured to have a high cycle capacity retention rate. In some other embodiments, 8≤W₀≤10, such that the battery has a lower battery core expansion rate and better furnace-temperature test result.

By controlling the content W₀ of the fluorinated carbonate in the electrolyte solution in an appropriate range, a stable SEI film is formed on the surface of the negative electrode, the battery is ensured to have a long cycle ability, the failure in furnace-temperature performance of the battery caused by an unstable SEI film is avoided, and the gas generation due to oxidative decomposition of the fluorinated carbonate at the positive electrode is alleviated, to avoid the obvious expansion in thickness of the battery core, and ensure the good furnace-temperature performance of the battery. In some embodiments, W₀ is in the range of 5≤W₀≤10. When W₀ is in this range, the lithium battery can have a long cycle performance, and reduce the expansion of the battery as much as possible.

In an embodiment of the present disclosure, the nitrile substance includes one or more of succinonitrile, adipodinitrile, glutaronitrile, butenedinitrile, 1,4-dicyano-2-butene, 3,3′-oxydipropionitrile, ethylene glycol diacetonitrile ether, 1,2,3-tri(2-cyanooxy)propane, 1,3,5-pentanetricarbonitrile, 1,2,3-propanetricarbonitrile, 1,3,6-hexanetricarbonitrile, and 1,2,3-tri(2-cyanooxy)propane.

In some embodiments of the present disclosure, W₁ is in the range of 2≤W₁≤10. That is, based on the total weight of the electrolyte solution, the weight content of the nitrile substance is about 2%-10%. In an embodiment, the weight content may be 2%, 2.5%, 3%, 3.3%, 4%, 4.6%, 5%, 5.5%, 6%, 7%, 8%, 9%, or 10%.

By controlling the content W₁ of the nitrile substance in the electrolyte solution in an appropriate range, the positive electrode interface is fully protected, and the electrolyte solution is not prone to oxidation and decomposition to produce gas, so that the battery has a good furnace-temperature performance and cycle performance. The electrolyte solution is ensured to have a suitable viscosity, the lithium ion transmission rate is appropriate, the battery impedance will not increase obviously, the lithium plating is unlikely to occur on the negative electrode during the long cycle process, the capacity retention rate of the battery is high, and the thickness of the battery core does not increase obviously.

In some embodiments of the present disclosure, the ratio of W₀ to W₁ meets 0.5≤W₀/W₁≤4. That is, the weight ratio of the fluorinated carbonate to the nitrile substance is in the range of 0.5-4. This can not only ensure that a stable and uniform SEI film is formed on the surface of the negative electrode during the cycle process, but also ensure that the positive electrode interface is effectively protected, whereby the battery can have good cycle performance, furnace-temperature performance, and non-obvious battery core expansion. In an embodiment, W₀/W₁ may be 0.8, 1.0, 1.2, 1.5, 1.6, 1.7, 1.8, 2.0, 2.2, 2.3, 2.5, 2.6, 2.8, 3.0, or 3.5. In some embodiments, W₀/W₁ is in the range of 1.5-3.0. In this case, the lithium battery can have a long cycle performance and a good furnace-temperature performance. In an embodiment, W₀/W₁ is in the range of 1.5-2.5.

The electrolyte solution of the lithium battery according to the present disclosure includes a lithium salt, an organic solvent, and an additive. The additive includes the fluorinated carbonate and the nitrile substance. In some embodiments of the present disclosure, the organic solvent includes a carboxylate substance. The carboxylate substance is generally a linear ester, which can reduce the viscosity of the electrolyte solution to ensure the electrolyte solution to have a good fluidity, and ensure the infiltration of the electrolyte solution to the electrode plate and the separator and the low-temperature discharging performance of the battery. The carboxylate substance includes one or more of ethyl acetate, propyl acetate, ethyl propionate, propyl propionate (PP), butyl propionate, pentyl propionate, ethyl haloacetate, ethyl halopropionate, propyl halopropionate, butyl halopropionate, and amyl halopropionate.

In some embodiments of the present disclosure, the organic solvent may include a cyclic carbonate. That is, the organic solvent at this time includes a carboxylate substance and a cyclic carbonate. The cyclic carbonate promotes the dissociation of the lithium salt in the electrolyte solution, and ensures the electrolyte solution to have a good ionic conductivity. The presence of the carboxylate substance reduces the viscosity of the electrolyte solution, improves the infiltrability by the electrolyte solution, promotes the formation of a uniform and stable SEI film, improves the ionic conductivity, and improves the rate performance and cycle performance of the battery. The combination of the two facilitates the electrolyte solution to maintain a low viscosity and contributes to the solubility of the lithium salt in the electrolyte solution. The cyclic carbonate may include at least one of ethylene carbonate (EC), propylene carbonate (PC), butylene carbonate, haloethylene carbonate, halopropylene carbonate, and the like.

In some embodiments, the organic solvent may include a linear carbonate substance. That is, the organic solvent at this time includes a carboxylate substance, a cyclic carbonate, and a linear carbonate substance. The presence of the linear carbonate substance can reduce the viscosity of the electrolyte solution, to ensure the infiltrability of the electrolyte solution to the electrode plate and the separator. The linear carbonate substance may include at least one of dimethyl carbonate (DMC), methyl ethyl carbonate (EMC), diethyl carbonate (DEC), dipropyl carbonate (DPC), methyl propyl carbonate (MPC), ethyl propyl carbonate, halogenated dimethyl carbonate, halogenated ethyl methyl carbonate, halogenated diethyl carbonate, and the like.

In an embodiment of the present disclosure, based on the total weight of the electrolyte solution, the total weight content of the carboxylate substance is W₂%, and W₂/W₀≥2. This reduce the expansion rate of the battery during the cycle process. In some embodiments, 2.5≤W₂/W₀≤8. In this case, the lithium battery has good infiltrability by the electrolyte solution and good dynamic performance, which promotes the formation of a uniform SEI film on the surface of the negative electrode active material by the fluorinated carbonate, and facilitates the battery to have a low battery core expansion rate and a good capacity retention rate. In an embodiment, W₂/W₀ may be 2.6, 2.7, 2.8, 2.9, 3.0, 3.1, 3.2, 3.5, 4.0, 5.0, 6.0, 6.5, 7.0, 7.5, or 7.9. In some embodiments, W₂/W₀ is in the range of about 3.0-7.0.

In some embodiments of the present disclosure, the additives in the electrolyte solution may include, in addition to the fluorinated carbonate and the nitrile substance, one or more of 1,3-propanesultone (PS), vinylene carbonate (VC), and vinyl ethylene carbonate (VEC). These additives promote the formation of a stable SEI film during the cycle process of the battery. Particularly, 1,3-propanesultone is particularly helpful to improve the high temperature resistance, such as the furnace temperature performance, of the lithium battery.

The lithium salt includes one or more of lithium hexafluorophosphate (LiPF₆), lithium tetrafluoroborate (LiBF₄), lithium hexafluoroarsenate (LiAsF₆), lithium hexafluorosilicate (Li₂SiF₆), lithium hexafluoroantimonate (LiSbF₆), lithium perchlorate (LiClO₄), lithium bis(oxalato)borate (LiBOB), lithium difluoro(oxalato) borate (LiDFOB), sodium bis(fluorosulfonyl)imide (LiFSI, molecular formula LiN(SO₂F)₂), lithium bis(trifluoromethylsulfonyl)imide (LiTFSI, molecular formula LiN(SO₂CF₃)₂), lithium bis(perfluoroethylsulfonyl)imide (LiN(C₂F₅SO₂)₂), lithium trifluoromethylsulfonate (LiCF₃SO₃), and lithium perfluorobutylsulfonate (LiC₄F₉SO₃).

In an embodiment, the content in percent by weight of the lithium salt in the electrolyte solution may be 12%-18%. In this case, it is ensured that the transmission resistance of lithium ions in the electrolyte solution is not too large to make the rate performance of the battery worse, and that the viscosity of the electrolyte solution will not be too large to cause the failure to effectively infiltrate the positive/negative electrodes, affecting the performance of the battery.

In some embodiments of the present disclosure, D₁ is in the range of 30≤D₁≤90. That is, the thickness of the negative electrode active material layer is in the range of about 30 μm-90 μm. It is to be understood that whether the negative electrode plate is arranged with the negative electrode active material layer on one or two side surfaces, D₁ refers to the thickness of the single-sided negative electrode active material layer. In this case, the thickness of the negative electrode active material layer is appropriate, to facilitate the battery to have good normal-temperature cycle performance and furnace-temperature performance. In an embodiment, the negative electrode active material layer of an appropriate thickness facilitates the infiltration by the electrolyte solution, promotes the formation of a uniform and stable SEI film on the surface of the negative electrode active material, reduces the transmission resistance of lithium ions in the negative electrode, and permits the battery to pass the furnace-temperature test easily. By using the negative electrode active material layer of an appropriate thickness, the increase in thickness of the negative electrode SEI film and thus the consumption of active lithium caused by the continuous reduction of the electrolyte solution by an incomplete SEI film during the cycle process of the battery can also be avoided, to facilitate the battery to maintain a high capacity retention rate. Additionally, the negative electrode active material layer of an appropriate thickness can also ensure a suitable load of the negative electrode active material in the battery and a high energy density of the battery. In some embodiments, D₁ is in the range of about 40-80.

In some embodiments of the present disclosure, the particle size of the negative electrode active material meets 8≤Dᵥ50<Dᵥ90≤40. The particle size Dᵥ50 of the negative electrode active material can reflect the overall particle size distribution. A suitable particle size Dᵥ50 can ensure that the negative electrode active material has a suitable surface area, so that the consumption of the electrolyte solution, particularly, the fluorinated carbonate, will not be too fast during the cycle process of the battery, and the side reaction at the negative electrode will not be too violent, thus enabling the battery to have a high capacity retention rate during the long cycle process. Additionally, a suitable particle size Dᵥ50 of the negative electrode active material facilitates the negative electrode active material layer to have an appropriate porosity, which reduces the diffusion and migration resistance of ions in a liquid, and is ultimately beneficial to the rate performance and cycle performance of the battery. In some embodiments, 8≤Dᵥ50<36, for example, 8, 10, 12, 14, 16, 18, 20, 21, 23, 25, 27, 30, 32, 34, and 35. In some embodiments, Dᵥ50 is in the range of 8-30, or in the range of 8-20.

The particle size Dᵥ90 of the negative electrode active material can reflect the large particles contained therein. By controlling Dᵥ90 to be less than 40 μm, the negative electrode plate has a low processing difficulty, the negative electrode active material layer has a good flatness, the negative electrode active material is unlikely to be crushed to produce more active fracture surfaces, and the consumption of the electrolyte solution and the fluorinated carbonate in the formation and cycle process is low, thus ensuring the good cycle performance of the battery. In some embodiments, Dᵥ90 is in the range of 10-40, or in the range of 12-40, or in the range of 15-35. Generally, D₁ is greater than or equal to 1 time of Dᵥ90. This ensures that the negative electrode active material will not be crushed in the rolling process of the negative electrode plate, thus improving the stability of the negative electrode plate, improving the cycle performance of the battery, and alleviating the expansion of the battery core.

In an embodiment of the present disclosure, the negative electrode active material may include, but is not limited to, one or more of a carbon material, a silicon based material, a tin-based material, and lithium titanate. The carbon material includes one or more of soft carbon, hard carbon, carbon fibers, graphitized carbon microspheres, artificial graphite, and natural graphite. The silicon-based material includes one or more of elemental silicon, a silicon alloy, a silicon oxide, a silicon-carbon composite material, and silicon carbide, etc. The tin-based material includes one or more of elemental tin, tin oxide, a tin-based alloy, and a tin-carbon compound, etc. When the negative electrode active material includes multiple materials (for example, both graphite and elemental silicon), Dᵥ90 and Dᵥ50 refer to the relevant particle sizes of the mixed negative electrode active material.

In an embodiment of the present disclosure, the negative electrode active material layer may include a binder. In some cases, the negative electrode active material layer may include a conductive agent. The binder may include, but is not limited to, one or more of polyvinylidene fluoride (PVDF), polytetrafluoroethylene (PTFE), polyvinyl alcohol (PVA), polyacrylonitrile (PAN), polyimide (PI), polyacrylic acid (PAA), polyacrylonitrile (PAN), polyacrylate (such as polymethyl methacrylate, polymethyl acrylate, and polyethyl acrylate, etc.), polyolefin (such as polypropylene, and polyethylene, etc.), styrene butadiene rubber (SBR), carboxymethylcellulose (CMC), sodium carboxymethylcellulose (CMC-Na), and sodium alginate. The first conductive agent and the second conductive agent may be one or more independently selected from conductive carbon black (such as acetylene black, ketjen black, Supper P, and 350G carbon black, etc.), furnace black, carbon fibers, carbon nanotubes, and graphene, etc. However, the present disclosure is not limited thereto. The current collector (e.g., the negative electrode current collector) bearing the negative electrode active material may include, but is not limited to, a copper foil, a stainless steel foil, a copper alloy foil, a carbon-coated copper foil, or a copper-plated film, etc.

The negative electrode plate can be obtained by coating a negative electrode slurry containing the negative electrode active material, the binder and the conductive agent on the current collector, drying, and rolling. The current collector may be coated on one side surface or on two side surfaces. In other words, maybe one side surface of the current collector has the negative electrode active material layer, or two opposite side surfaces of the negative electrode current collector have the negative electrode active material layer. When the negative electrode current collector is coated on two side surfaces, the thickness D₁ μm of the negative electrode active material layer refers to the thickness of the negative electrode active material layer on one side. At this time, the thickness of the negative electrode active material layers on two sides of the negative electrode current collector may be the same or different, and the negative electrode active material layer on each side surface of the negative electrode current collector enables the parameter k to fall within the above range.

In the present disclosure, the lithium battery includes a positive electrode plate, a negative electrode plate, an electrolyte solution, and a separator located between the positive electrode plate and the negative electrode plate. The positive electrode active material in the positive electrode plate is a material where lithium ions can be reversibly deintercalated and intercalated. For the lithium battery, the positive electrode active material may include, but is not limited to, one or more of a lithium-unary oxide (such as lithium cobalt oxide, lithium nickel oxide, and lithium manganese oxide, etc.), a lithium-binary oxide (such as lithium nickel manganese oxide, lithium nickel cobalt oxide, and lithium cobalt manganese oxide, etc.), a lithium-ternary oxide (such as lithium nickel cobalt manganese oxide ternary material, or lithium nickel cobalt aluminum oxide ternary material), a lithium-multi-element oxide, and a lithium-containing phosphate (such as lithium iron phosphate, and lithium manganese iron phosphate). The separator can be made of any separator material in the existing battery. In an embodiment, the separator may include, but is not limited to, a polymer separator such as a single-layer polypropylene (PP) film, a single-layer polyethylene (PE) film, a two-layer PP/PE film, a two-layer PP/PP film, and a three-layer PP/PE/PP film, or non-woven cloth.

An embodiment of the present disclosure further provides an electric device. As shown in FIG. 2, an electric device 1 includes a lithium battery 10 according to the embodiment of the present disclosure.

In the present disclosure, there are no special restrictions on the electric device using the lithium battery. For example, the electric device includes, but is not limited to, a cell phone, a notebook computer, a tablet computer, a computer with stylus input, a portable fax machine, a portable copier, a portable printer, a transceiver, a video recorder, a camera, a television, a radio, a portable audio recorder, a portable CD player, a mini-disc, an electronic book player, an electronic diary, a wearable device (such as a smart watch, a smart bracelet, a headphone, and a bluetooth headset), a portable cleaner, a calculator, a memory card, a stand-by power source, a vehicle, a motorcycle, a bicycle (such as force-helping bicycle), a lighting appliance (such as flashlight), a toy, a game console, a clock, a power tool, a large household battery, and a lithium-ion capacitor, etc.

Due to the use of the lithium battery, the battery of the electric device has a long battery life, a good cycle performance, and a high safety performance.

Hereinafter, the technical solution of the present disclosure will be further described in combination with examples.

### Example 1

A lithium-ion battery was prepared through a process including the following steps.

### 1) Preparation of Electrolyte Solution:

In an argon-filled glove box with a water content of <1 ppm and an oxygen content of <1 ppm, various non-aqueous organic solvents were mixed according to the composition in Table 1, and the dry lithium salt LiPF₆ and the additives were added, to prepare an electrolyte solution containing 14.5% LiPF₆.

### 2) Preparation of Positive Electrode Plate:

A positive electrode active material (e.g., lithium cobalt oxide (LiCoO₂)), a conductive agent (e.g., carbon nanotubes (CNT)), and a binder (e.g., polyvinylidene fluoride) were mixed according to a weight ratio of 95:2:3. The mixed powder was added to a vacuum stirrer, and the solvent N-methylpyrrolidone (NMP) were added, and uniformly stirred to obtain a positive electrode slurry. The positive electrode slurry was coated on a positive electrode current collector that was an aluminum foil, dried at 85° C., cold-rolled, sliced, cut, and dried under vacuum at 85° C. for 4 h, to obtain a positive electrode plate.

### 3) Preparation of Negative Electrode Plate:

A negative electrode active material (e.g., graphite having a particle size and dimension parameter as shown in Table 1) and a binder (e.g., styrene-butadiene rubber (SBR) and sodium carboxymethyl cellulose (CMC-Na) at a weight ratio of 2:3) was mixed in ionic water according to a weight ratio of 95:5, and uniformly stirred in a vacuum stirrer, to obtain a negative electrode slurry. Then the negative electrode slurry was coated on two opposite side surfaces of a negative electrode current collector that was a copper foil, dried, cold-rolled, and cut, to obtain a negative electrode plate. The negative electrode plate includes a copper foil and negative electrode active material layers arranged on two opposite side surfaces of the copper foil. The thickness of each negative electrode active material layer is summarized in Table 1.

### 4) Assembly of Battery:

In an argon-filled glove box, the positive electrode plate, a polyethylene (PE) separator, and the negative electrode plate were stacked in sequence, to obtain a battery core. The stacked battery core was wound and placed in an aluminum-plastic film that was an outer packaging foil, and the prepared electrolyte solution was injected, followed by vacuum packaging, standing, formation, shaping and other procedures. In this way, the preparation of the lithium battery was completed. The calculation results of the performance factor k of the obtained lithium batteries are also summarized in Table 1.

It is to be understood that the sequence of implementing some operations involved in the preparation method of the lithium ion battery is not limited in the present disclosure. For example, operations 1), 2), and 3) may be implemented at the same time, or implemented in a sequence different from the sequence described herein.

### OTHER EXAMPLES

Following the preparation method of the battery in Example 1, lithium batteries in other examples and comparative examples were prepared according to the parameters listed in Table 1.

TABLE 1
Parameters of lithium batteries in various examples and comparative examples

| | 2D1 | Dᵥ50 | Dᵥ90 | | PS | W₀ | W₁ | | | W₂ | |
|---|---|---|---|---|---|---|---|---|---|---|---|
| | (μm) | (μm) | (μm) | EC:PC:DEC:PP | (%) | (%) | (%) | k | W₀/W₁ | (%) | W₂/W₀ |
| Example 1 | 170 | 14 | 30 | 2:2:3:3 | 3.5 | 7 | 4 | 1.79 | 1.75 | 21.3 | 3.04 |
| Example 2 | 150 | 14 | 30 | 2:2:3:3 | 3.5 | 7 | 4 | 1.73 | 1.75 | 21.3 | 3.04 |
| Example 3 | 120 | 14 | 30 | 2:2:3:3 | 3.5 | 7 | 4 | 1.64 | 1.75 | 21.3 | 3.04 |
| Example 4 | 90 | 14 | 30 | 2:2:3:3 | 3.5 | 7 | 4 | 1.55 | 1.75 | 21.3 | 3.04 |
| Example 5 | 60 | 14 | 30 | 2:2:3:3 | 3.5 | 7 | 4 | 1.45 | 1.75 | 21.3 | 3.04 |
| Example 6 | 50 | 14 | 30 | 2:2:3:3 | 3.5 | 7 | 4 | 1.42 | 1.75 | 21.3 | 3.04 |
| Example 7 | 190 | 14 | 30 | 2:2:3:3 | 3.5 | 7 | 4 | 1.85 | 1.75 | 21.3 | 3.04 |
| Example 8 | 90 | 8 | 30 | 2:2:3:3 | 3.5 | 7 | 4 | 1.00 | 1.75 | 21.3 | 3.04 |
| Example 9 | 90 | 10 | 30 | 2:2:3:3 | 3.5 | 7 | 4 | 1.18 | 1.75 | 21.3 | 3.04 |
| Example 10 | 90 | 12 | 30 | 2:2:3:3 | 3.5 | 7 | 4 | 1.36 | 1.75 | 21.3 | 3.04 |
| Example 11 | 90 | 16 | 30 | 2:2:3:3 | 3.5 | 7 | 4 | 1.73 | 1.75 | 21.3 | 3.04 |
| Example 12 | 90 | 18 | 30 | 2:2:3:3 | 3.5 | 7 | 4 | 1.91 | 1.75 | 21.3 | 3.04 |
| Example 13 | 90 | 30 | 36 | 2:2:3:3 | 3.5 | 7 | 4 | 2.95 | 1.75 | 21.3 | 3.04 |
| Example 14 | 90 | 10 | 15 | 2:2:3:3 | 3.5 | 7 | 4 | 1.45 | 1.75 | 21.3 | 3.04 |
| Example 15 | 90 | 14 | 25 | 2:2:3:3 | 3.5 | 7 | 4 | 1.60 | 1.75 | 21.3 | 3.04 |
| Example 16 | 90 | 14 | 35 | 2:2:3:3 | 3.5 | 7 | 4 | 1.50 | 1.75 | 21.3 | 3.04 |
| Example 17 | 90 | 14 | 40 | 2:2:3:3 | 3.5 | 7 | 4 | 1.48 | 1.75 | 21.3 | 3.04 |
| Example 18 | 90 | 14 | 40 | 2:2:3:3 | 3.5 | 5 | 4 | 1.89 | 1.25 | 21.9 | 4.38 |
| Example 19 | 90 | 14 | 40 | 2:2:3:3 | 3.5 | 8 | 4 | 1.42 | 2.00 | 21.0 | 2.63 |
| Example 20 | 90 | 14 | 40 | 2:2:3:3 | 3.5 | 10 | 4 | 1.21 | 2.50 | 20.4 | 2.04 |
| Example 21 | 90 | 14 | 30 | 2:2:3:3 | 3.5 | 12 | 4 | 1.06 | 3.00 | 19.8 | 1.65 |
| Example 22 | 90 | 14 | 30 | 2:2:3:3 | 3.5 | 16 | 4 | 0.85 | 4.00 | 18.6 | 1.16 |
| Example 23 | 90 | 14 | 30 | 2:2:3:3 | 3.5 | 20 | 4 | 0.71 | 5.00 | 17.4 | 0.87 |
| Example 24 | 90 | 14 | 30 | 2:2:3:3 | 3.5 | 7 | 6 | 1.31 | 1.67 | 20.7 | 2.96 |
| Example 25 | 90 | 14 | 30 | 2:2:3:3 | 3.5 | 7 | 10 | 1.00 | 0.70 | 19.5 | 2.79 |
| Example 26 | 90 | 14 | 30 | 2:2:3:3 | 3.5 | 7 | 12 | 0.89 | 0.58 | 18.9 | 2.70 |
| Example 27 | 90 | 14 | 30 | 2:2:3:3 | 3.5 | 7 | 4 | 1.54 | 1.75 | 21.3 | 3.04 |
| Example 28 | 90 | 14 | 30 | 2:2:3:3 | 3.5 | 7 | 4 | 1.54 | 1.75 | 21.3 | 3.04 |
| Example 29 | 90 | 14 | 30 | 2:2:3:3 | 3.5 | 7 | 4 | 1.54 | 1.75 | 21.3 | 3.04 |
| Example 30 | 90 | 14 | 30 | 2:2:3:3 | 3.5 | 7 | 4 | 1.54 | 1.75 | 21.3 | 3.04 |
| Example 31 | 90 | 14 | 30 | 2:2:3:3 | 3.5 | 7 | 4 | 1.54 | 1.75 | 21.3 | 3.04 |
| Example 32 | 90 | 14 | 30 | 2:2:3:3 | 0 | 7 | 4 | 1.55 | 1.75 | 22.4 | 3.19 |
| Example 33 | 90 | 14 | 30 | 2:2:0:6 | 3.5 | 7 | 4 | 1.54 | 1.75 | 42.6 | 6.09 |
| Example 34 | 90 | 14 | 30 | 2:2:6:0 | 3.5 | 7 | 4 | 1.54 | 1.75 | 0 | 0 |
| Comparative | 90 | 14 | 30 | 2:2:3:3 | 3.5 | 30 | 12 | 0.40 | 2.50 | 12 | 0.40 |
| Example 1 | | | | | | | | | | | |
| Comparative | 90 | 8 | 30 | 2:2:3:3 | 3.5 | 14 | 10 | 0.46 | 1.40 | 17.4 | 1.24 |
| Example 2 | | | | | | | | | | | |
| Comparative | 90 | 14 | 30 | 2:2:3:3 | 3.5 | 2 | 2 | 4.25 | 1.00 | 23.4 | 11.70 |
| Example 3 | | | | | | | | | | | |
| Comparative | 90 | 14 | 30 | 2:2:3:3 | 3.5 | 0 | 4 | 4.25 | 0 | 23.4 | / |
| Example 4 | | | | | | | | | | | |
| Comparative | 90 | 14 | 30 | 2:2:3:3 | 3.5 | 7 | 0 | 2.43 | / | 22.5 | 3.21 |
| Example 5 | | | | | | | | | | | |

Note: In table 1, EC represents the cyclic carbonate solvent ethylene carbonate, PC represents the cyclic carbonate solvent propylene carbonate, DEC represents the linear carbonate solvent diethyl carbonate, and PP represents the carboxylate solvent propyl propionate. PS represents the additive 1,3-propanesultone.

In Examples 1-26 and 32-34 and Comparative Examples 1-5, W₀ represents the weight percentage of fluoroethylene carbonate in the electrolyte solution, and W₁ represents the total weight percentage of 1,3,6-hexanetricarbonitrile and succinonitrile in the electrolyte solution. In Example 27, W₀ represents the weight percentage of 4,5-difluoroethylene carbonate in the electrolyte solution. In Example 28, W₀ represents the weight percentage of 4,4,5,5-tetrafluoroethylene carbonate in the electrolyte solution. In Examples 27-28, W₁ represents the total weight percentage of 1,3,6-hexanetricarbonitrile and succinonitrile in the electrolyte solution. In Examples 29-31, W₀ represents the weight percentage of fluoroethylene carbonate in the electrolyte solution. In Example 29, W₁ represents the total weight percentage of 1,3,6-hexanetricarbonitrile and adiponitrile in the electrolyte solution. In Example 30, W₁ represents the weight percentage of succinonitrile in the electrolyte solution. In Example 31, W₁ represents the weight percentage of adiponitrile in the electrolyte solution.

To provide powerful support for the beneficial effects of the present disclosure, the lithium battery of each example and comparative example was tested for the following electrochemical performances. The results are summarized in Table 2 below.

### 1) Normal-Temperature Cycle Performance Test:

5 test lithium batteries were charged with a constant current to a cut-off voltage of 4.48 V at a rate of 1 C at normal temperature (25±3° C.), and then constant-voltage charged to a cut-off current of 0.05 C at 4.48 V, so that the batteries were fully charged. The batteries were allowed to stand for 5 min. Then the batteries were discharged to 3.0 V at a rate of 1 C with a constant current, and allowed to stand for 5 min. This was a charging and discharging cycle. The capacity retention rate and thickness expansion rate after 1000 cycles at normal temperature were recorded.

$$Capacity retention rate after 1000 cycles = ( discharging capacity after 1000 cycles / first discharging capacity ) * 100 \% Battery thi ckness expansion rate = ( battery thickness when fully charged in the 1000 th cycle / battery thickness when fully charged for the first time ) * 100 \%$$

### 2) Furnace-Temperature Performance Test at 130° C.:

5 lithium batteries in each group were tested. The batteries were charged with a constant current to a cut-off voltage of 4.48 V at a rate of 1 C at normal temperature (25±3° C.), and then were charged with a constant current to a cut-off current of 0.05 C at 4.48 V, so that the batteries were fully charged. Then the furnace-temperature test was carried out 12-24 h after the batteries were fully charged (note: the fully charged battery was left to stand for 12 h or more, and could not be tested immediately). Each lithium battery was heated from an initial temperature of 25±3° C. convectively or in a circulating hot air box, where the heating rate was controlled to 5±2° C./min, and the heating time was controlled to 25-28 min. The battery was heated to 130±2° C., and maintained at this temperature for 60 min. Then the test was completed. Whether smoking, flame, or explosion occurred to each lithium battery was observed. If the lithium battery did not have the above signs, the lithium battery was considered to pass the furnace-temperature test, and recorded as OK. If the lithium battery had the above signs, the lithium battery was considered not to pass the furnace-temperature test, and recorded as NG. The number of batteries passing the furnace-temperature test in each group of 5 batteries was recorded.

TABLE 2
Summary of performance test results of lithium
batteries in examples and comparative Examples

| | Capacity retention | Expansion rate of | |
|---|---|---|---|
| | rate after 1000 | battery after 1000 | |
| | cycles at normal | cycles at normal | Furnace-temperature |
| | temperature (%) | temperature/% | test at 130° C. |
| Example 1 | 80.4 | 10.6 | 8/10 OK |
| Example 2 | 85.1 | 8.4 | 9/10 OK |
| Example 3 | 87.8 | 8.1 | 10/10 OK |
| Example 4 | 88.4 | 8.0 | 10/10 OK |
| Example 5 | 89.8 | 7.9 | 10/10 OK |
| Example 6 | 84.1 | 14.6 | 7/10 OK |
| Example 7 | 75.8 | 13.5 | 7/10 OK |
| Example 8 | 82.5 | 8.6 | 10/10 OK |
| Example 9 | 84.0 | 8.5 | 10/10 OK |
| Example 10 | 87.6 | 8.3 | 10/10 OK |
| Example 11 | 87.8 | 8.2 | 10/10 OK |
| Example 12 | 88.7 | 8.2 | 10/10 OK |
| Example 13 | 78.8 | 11.8 | 8/10 OK |
| Example 14 | 88.6 | 9.2 | 10/10 OK |
| Example 15 | 88.0 | 8.4 | 10/10 OK |
| Example 16 | 87.5 | 8.5 | 10/10 OK |
| Example 17 | 85.1 | 8.4 | 10/10 OK |
| Example 18 | 76.4 | 12.7 | 10/10 OK |
| Example 19 | 88.4 | 8.0 | 10/10 OK |
| Example 20 | 88.5 | 9.7 | 9/10 OK |
| Example 21 | 88.6 | 10.6 | 8/10 OK |
| Example 22 | 88.7 | 12.0 | 7/10 OK |
| Example 23 | 88.6 | 14.7 | 6/10 OK |
| Example 24 | 81.6 | 12.4 | 10/10 OK |
| Example 25 | 78.2 | 13.3 | 10/10 OK |
| Example 26 | 75.2 | 15.3 | 10/10 OK |
| Example 27 | 86.4 | 8.6 | 10/10 OK |
| Example 28 | 85.5 | 9.0 | 10/10 OK |
| Example 29 | 87.0 | 8.1 | 10/10 OK |
| Example 30 | 85.0 | 9.2 | 7/10 OK |
| Example 31 | 84.1 | 9.3 | 7/10 OK |
| Example 32 | 86.3 | 9.8 | 6/10 OK |
| Example 33 | 89.0 | 7.8 | 10/10 OK |
| Example 34 | 83.8 | 13.4 | 10/10 OK |
| Comparative | 50.4 | 60.2 | 10/10 NG |
| Example 1 | | | |
| Comparative | 53.6 | 23.5 | 7/10 NG |
| Example 2 | | | |
| Comparative | / | / | 10/10 NG |
| Example 3 | | | |
| Comparative | / | / | 10/10 NG |
| Example 4 | | | |
| Comparative | / | / | 10/10 NG |
| Example 5 | | | |

Note:
In Table 2, “/”means that the cycle life of the lithium battery fails to reach 1000 cycles.

As shown in Tables 1 and 2, when the additives in the electrolyte solution of the lithium battery contain both the fluorinated carbonate and the nitrile additive, and the battery composition enables its performance factor k to fall within the range of 0.5-3.0, the lithium battery has a good normal-temperature cycle performance, high capacity, and low thickness expansion rate of the battery core, and passes the furnace-temperature performance test at 130° C. Particularly, when k is 1.0-2.0, the various performances of the battery are good. When (2D₁/Dᵥ90+Dᵥ50)/(W₀+W₁) (that is, performance factor k) is lower than 0.5 or greater than 3 (Comparative Examples 1-3), the long cycle performance and furnace-temperature performance of the lithium battery are poor, and obviously inferior to those of Example 4 where the characteristic parameters of the negative electrode plate and the organic solvent composition are the same. Additionally, when the electrolyte solution of the lithium battery does not contain the fluorinated carbonate or the additive, the performances of the battery are poor. Even if the parameter k is in the range of 0.5-3 (Comparative Example 5), the cycle life of the lithium battery is very poor. For example, the number of cycles is difficult to reach 1000 cycles, and the pass rate of furnace-temperature test is as low as 0.

In addition, from the comparison between Examples 1-5 and 6-7, it can be known that when the thickness D₁ of the negative electrode active material layer is different and other conditions are the same, if k is 0.5-3, the various performances of the battery are good when the thickness of D₁ of the negative electrode active material layer is in the range of 30-90 μm (that is, 2D₁ in the range of 60-180 μm), particularly when D₁ is 30-75 μm (that is, 2D₁ is in the range of 60-150 μm).

In Examples 18-26, the thickness D₁ of the negative electrode active material layer, the particle size parameter of the negative electrode active material, and the organic solvent and the additive PS in the electrolyte solution, are the same, and the content W₀ of the fluorinated carbonate and the content W₁ of the nitrile substance are different. From the comparison between Example 18 and Example 23, it can be known that under the same conditions, when the content W₀ of the fluorinated carbonate in the system is in the range of 2-16, the cycle performance and various other performances of the battery are well balanced, and especially the expansion resistance is good. Particularly, when W₀ is in the range of 6-12, W₀/W₁ is in a range of 1.5-3.0, and k is in a range of 1-2, the battery has excellent comprehensive performance. If W₂/W₀ is equal or greater than 2, the comprehensive performance is much better. Additionally, from the comparison of Example 26 with Examples 4 and 24-25, it can be known that when other conditions are the same and the W₁ content of the nitrile additive in the system is in the range of 2-10, the battery can maintain a good furnace-temperature performance. Moreover, the viscosity of the electrolyte solution is appropriate, the battery impedance is small, the cycle performance of the battery is excellent and the thickness expansion rate is small.

In addition, from the comparison of Example 4 and Examples 33-34, it can be known that compared with the organic solvent in the electrolyte solution that is a pure carbonate system (for example, Example 34 containing only EC, PC, and DEC), the introduction of a carboxylate improves the long cycle performance of the battery. That is, the cycle performance in Examples 4 and 33 is better than that in Example 34, which can be attributed to the addition of the carboxylate solvent. The addition of the carboxylate solvent reduces the viscosity of the electrolyte solution, improves the infiltrability to the negative electrode, promotes the formation of a uniform and stable SEI film, improves the capacity retention rate in the cycle process, and reduces the thickness expansion rate. Furthermore, from the comparison between Example 4 and Example 32, when the additives in the electrolyte solution include both the fluorinated carbonate and the nitrile additive with the same composition and the parameters of the organic solvent and the negative electrode plate are the same, the introduction of the additive 1,3-propanesultone (PS) can further improve the high-temperature resistance of the battery.

Embodiments of the present disclosure have been described above, but which cannot be understood as a limitation on the scope of the present disclosure. It should be noted that several improvements and modifications can be made by those of ordinary skill in the art without departing from the principle of the present disclosure, which shall fall within the protection scope of the present disclosure.

### LIST OF REFERENCE NUMERALS

1: electric device, 10: lithium battery, 110: positive electrode plate, 111: positive electrode current collector, 112: positive electrode active material layer, 120: negative electrode plate, 121: negative electrode current collector, 122: negative electrode active material layer, 130: separator, and 140: electrolyte solution.

What is claimed is:

1. A lithium battery, comprising a positive electrode plate, a negative electrode plate, a separator, and an electrolyte solution,
the negative electrode plate comprising a current collector and a negative electrode active material layer disposed on at least one side surface of the current collector, the electrolyte solution comprising a lithium salt, an organic solvent, and an additive, and the additive comprising a fluorinated carbonate and a nitrile substance, wherein:
the negative electrode active material layer has a thickness of D₁ μm, a corresponding particle size is Dᵥ50 μm when a negative electrode active material contained in the negative electrode active material layer has a volume cumulative distribution percentage of 50%, and a corresponding particle size is Dᵥ90 μm when the negative electrode active material contained in the negative electrode active material layer has a volume cumulative distribution percentage of 90%;
based on a total weight of the electrolyte solution, a weight content of the fluorinated carbonate is W₀%, and a weight content of the nitrile substance is W₁%;
the lithium battery has a performance factor k, k=(2D₁/Dᵥ90+Dᵥ50)/(W₀+W₁), and k is from about 0.5 to about 3.0.

2. The lithium battery according to claim 1, wherein k is from about 1.0 to about 2.0.

3. The lithium battery according to claim 1, wherein W₀ is from about 2 to about 16.

4. The lithium battery according to claim 1, wherein W₀ is from about 5 to about 10.

5. The lithium battery according to claim 1, wherein W₁ is from about 2 to about 10.

6. The lithium battery according to claim 1, wherein a ratio W₀/W₁ of W₀ to W₁ is from about 0.5 to about 4.

7. The lithium battery according to claim 1, wherein a ratio W₀/W₁ of W₀ to W₁ is from about 1.5 to about 3.0.

8. The lithium battery according to claim 1, wherein D₁ is from about 30 to about 90.

9. The lithium battery according to claim 1, wherein D₁ is from about 40 to about 80.

10. The lithium battery according to claim 1, wherein particle sizes of the negative electrode active material meet: 8≤Dᵥ50<Dᵥ90≤40.

11. The lithium battery according to claim 1, wherein a ratio D₁/Dᵥ90 of D₁ to Dᵥ90 is greater than or equal to 1.

12. The lithium battery according to claim 1, wherein:
the fluorinated carbonate comprises at least one of fluoroethylene carbonate, 4,5-difluoroethylene carbonate, 4,4,5,5-tetrafluoroethylene carbonate, and 4-trifluoromethylethylene carbonate; and
the nitrile substance comprises at least one of succinonitrile, adipodinitrile, glutaronitrile, butenedinitrile, 1,4-dicyano-2-butene, 3,3′-oxydipropionitrile, ethylene glycol diacetonitrile ether, 1,2,3-tri(2-cyanooxy)propane, 1,3,5-pentanetricarbonitrile, 1,2,3-propanetricarbonitrile, and 1,3,6-hexanetricarbonitrile.

13. The lithium battery according to claim 1, wherein
the organic solvent comprises a carboxylate substance, and
the carboxylate substance comprises at least one of ethyl acetate, propyl acetate, ethyl propionate, propyl propionate, butyl propionate, pentyl propionate, ethyl haloacetate, ethyl halopropionate, propyl halopropionate, butyl halopropionate, and amyl halopropionate.

14. The lithium battery according to claim 13, wherein the organic solvent further comprises a cyclic carbonate.

15. The lithium battery according to claim 14, wherein the organic solvent further comprises a linear carbonate substance.

16. The lithium battery according to claim 13, wherein based on the total weight of the electrolyte solution, a total weight content of the carboxylate substance is W₂%, and W₂/W₀≥2.

17. The lithium battery according to claim 16, wherein a ratio W₂/W₀ of W₂ to W₀ is about 2.5 to about 8.

18. The lithium battery according to claim 1, wherein the additive further comprises at least one of 1,3-propanesultone, vinylene carbonate, and vinylethylene carbonate.

19. An electric device, comprising a lithium battery, the lithium battery comprising a positive electrode plate, a negative electrode plate, a separator, and an electrolyte solution,
the negative electrode plate comprising a current collector and a negative electrode active material layer disposed on at least one side surface of the current collector, the electrolyte solution comprising a lithium salt, an organic solvent, and an additive, and the additive comprising a fluorinated carbonate and a nitrile substance, wherein:
the negative electrode active material layer has a thickness of D₁ μm, a corresponding particle size is Dᵥ50 μm when a negative electrode active material contained in the negative electrode active material layer has a volume cumulative distribution percentage of 50%, and a corresponding particle size is Dᵥ90 μm when the negative electrode active material contained in the negative electrode active material layer has a volume cumulative distribution percentage of 90%;
based on a total weight of the electrolyte solution, a weight content of the fluorinated carbonate is W₀%, and a weight content of the nitrile substance is W₁%;
the lithium battery has a performance factor k, k=(2D₁/Dᵥ90+Dᵥ50)/(W₀+W₁), and k is from about 0.5 to about 3.0.
